(19) United States
(12) Patent Application Publication
(10) Pub. No.: US 2026/0336444 A1
(43) Pub. Date: Oct. 29, 2026

(54) ENERGY-SUPPLY SYSTEM FOR AN ELECTRICALLY DRIVEN MACHINE WITH AN INTERNALLY COOLED CABLE

(71) Applicant: LEONI KABEL GMBH, Roth (DE)

(72) Inventor: SEBASTIAN GOSS, ROTH (DE)

(21) Appl. No.: 19/102,530

(22) PCT Filed: Aug. 24, 2023
(86) PCT No.: PCT/EP2023/073215

§ 371 Date: Feb. 10, 2025

(30) Foreign Application Priority Data
Sep. 1, 2022 (DE) 10 2022 122 135.0

(51) Int. Cl. B60L 53/302; B60L 53/16; B60L 53/18; H01B 7/42; H01R 13/00; H01R 13/639

(52) U.S. Cl. CPC B60L 53/302; B60L 53/16; B60L 53/18; H01B 7/423; H01R 13/005; H01R 13/639; H01R 2201/26

(57) ABSTRACT

An energy-supply system for an electrically driven machine has an internally cooled cable including at least one line for electrical power and at least one coolant line, wherein at least a section of the coolant line is separate from the line for electrical power, and has a connection device for the internally cooled cable, which includes a contacting device and a coolant guide. The connection device is designed to be mechanically coupled to a connection element of the internally cooled cable. The contacting device is designed to establish electrical contact of the at least one line for electrical power when the connection device is mechanically coupled to the connection element of the cable. The energy-supply system is also designed to release a transfer of coolant from a section of the coolant line of the internally cooled cable that is separate from the line for electrical power to the coolant guide of the connection device or from the coolant guide of the connection device to the section of the coolant line of the internally cooled cable that is separate from the line for electrical power when the connection device is mechanically coupled to the connection element of the cable.

### RELATED APPLICATIONS

This application filed under 35 U.S.C § 371 is a national phase application of International Application Number PCT/EP2023/073215, filed Aug. 24, 2023, which claims the benefit of German Application No. 10 2022 122 135.0 filed Sep. 1, 2023, the subject matter of which are incorporated herein by reference in their entirety.

### TECHNICAL FIELD

There are described herein an energy-supply system and an associated method for an electrically driven machine. The energy-supply system comprises at least one internally cooled cable.

### BACKGROUND

Machines that are driven by electrical energy comprise cable connections for the supply of electric current. In particular machines that cannot or are not to be installed and operated statically, for example motor vehicles, further comprise a connection device for detachable coupling to a power cable, and a storage device for electrical energy, for example an accumulator.

In order to charge the storage device of a machine that is not static and is driven by electrical energy in a time- and resource-efficient manner and thus establish a relationship between useful life and charging time that is acceptable for mobile operation, the storage devices are in most cases charged with high charging powers, in particular with high charging currents.

During charging, both the cable used for charging the machine and the machine itself can get very hot. Heating of the cable and of the machine are not desirable, however, since their handleability by an operator is thus adversely affected and an electrical resistance and thus the power loss of the charging cable and of the connection device of the machine are increased.

Undesirably pronounced heating can occur in particular at an electrical contacting point between the charging cable that is used and the connection device of an electrically driven machine, since an electrical resistance is higher here than within an electrical conductor formed in one piece, for example within an electrical line of the cable.

In order to counteract this problem, it is known to cool the connection device of an electrically driven machine with coolant, for example with a cooling liquid. An example thereof is disclosed in document EP 3 766 726 A1.

A first disadvantage here is that, in addition to the actual charging cable, further cables for supplying and discharging coolant must be installed at the electrically driven machine and must be removed again when charging has taken place, or that, in the case of an integrated cooling system, the machine must continue to be operated continuously at least in part during the charging process and cannot be switched off completely.

A second disadvantage is that the electrically conducting connection between the electrical line of a charging cable and the connection device of a machine is always also a thermally conducting connection. A coolant guide of the connection device thus dissipates the heat not only from the electrical contacting point between the charging cable that is used and the connection device, but also from a cable end of the charging cable that faces the machine. The coolant guide for the connection device must therefore on the one hand be very powerful and on the other hand results in an undesirable temperature gradient and thus resistance gradient within the cable itself, which leads to an inhomogeneous power loss distribution within the cable.

Cables with electrical lines and integrated coolant lines are further known, for example from documents DE 19 921 310 A1, DE 10 2020 117 588 A1, DE 10 2017 115 241 A1 and U.S. Pat. No. 9,287,646 B2.

A disadvantage of internally cooled cables is, however, that they are not compatible with the cooling system of the connection devices and thus further increase the outlay in terms of installation for a charging process. In particular, separate coolant circuits have to be set up and operated for the cables. In addition, it is difficult to synchronize the cooling powers of the internally cooled cables with the cooling power of the connection device, so that, despite universal cooling of the various system components, an undesirable temperature gradient and thus resistance gradient can persist in the region of the connection device.

There is therefore a need for an improved energy-supply system for an electrically driven machine which overcomes the disadvantages described above.

### SUMMARY

An energy-supply system for an electrically driven machine has an internally cooled cable, which comprises at least one line for electric current and at least one coolant line for a liquid or gaseous coolant, and a connection device for the internally cooled cable, which connection device comprises a contacting device and a coolant guide. At least a section of the coolant line is separate or spatially spaced apart from the line for electric current. Spatially spaced apart can here be understood as meaning that the section of the coolant line that is separate from the line for electric current is not in contact with the line for electric current. The connection device is adapted to be mechanically coupled to a connection element of the internally cooled cable. The contacting device is adapted to electrically contact the at least one line for electric current when the connection device is mechanically coupled to the connection element of the cable.

Mechanically coupled means that the connection device and the connection element of the cable have been brought into contact with one another such that they do not become detached from one another without the application of an external force and are connected together to form a charging operating arrangement.

In other words, the connection device can be adapted to receive the connection element of the internally cooled cable and to electrically contact the line for electric current, for example by way of the connection element, which can comprise an electrically conducting production material. The connection element can comprise, for example, at least one metal pin, which can be inserted into a correspondingly formed cavity in the connection device. The connection device can be so formed that a connection element coupled thereto and/or inserted therein can be removed again, that is to say separated from the connection device, only against a pressure resistance.

The energy-supply system is further adapted to enable a transfer of a liquid or gaseous coolant from a section of the coolant line of the internally cooled cable that is separate from the line for electric current, for example from the coolant line, to the coolant guide of the connection device, or from the coolant guide of the connection device to the section of the coolant line of the internally cooled cable that is separate from the line for electric current, for example to the coolant line, when the connection device is mechanically coupled to the connection element of the cable. The transfer of coolant can here take place in particular spatially spaced apart from the contacting device.

In other words, coolant can be exchanged between the internally cooled cable and the connection device and/or coolant can be introduced from the cable into the connection device and/or discharged from the connection device into the cable when the connection device is mechanically coupled to the connection element of the cable.

The connection device can thus be supplied with coolant through the cable. A separate coolant supply for the connection device can therefore be omitted, as can the provision of a cooling system integrated in the machine. Furthermore, by connecting the coolant supply of the internally cooled cable and the coolant supply of the connection device, separate control or adjustment as well as synchronization of two or more different cooling circuits can be omitted. Because the line for electric current of the internally cooled cable and the connection device can be cooled by the same coolant, the occurrence of an undesirable temperature gradient and thus resistance gradient within the cable and in the region of the connection device can also be avoided.

The electrically driven machine can be in particular a motor vehicle, for example an electrically driven passenger car or truck, or an electrically driven passenger bike or cargo bike, for example an electrically driven motorcycle.

The connection device for the internally cooled cable can be arranged at the electrically driven machine and/or is integrated in the electrically driven machine. The connection device can be an integral component of the machine or can be connected thereto in a modular, that is to say detachable and/or replaceable, manner.

An advantage here is that a coolant guide arranged integrally or detachably in or at the driven machine can be supplied with a liquid or gaseous coolant through the coolant line of the internally cooled cable.

The connection device can optionally comprise a storage device for electrical energy, wherein the connection device for the internally cooled cable can be adapted to charge the storage device with electrical energy supplied through the line for electric current of the internally cooled cable when the connection device is mechanically coupled to the connection element of the cable.

The storage device for electrical energy can be, for example, an accumulator. In a variant of the energy-supply system, the storage device for electrical energy can be an energy store of an electrically driven motor vehicle.

The connection device can further comprise at least one locking element, which is adapted to mechanically fix the internally cooled cable, in particular the connection element of the internally cooled cable, and/or to connect together the coolant line of the internally cooled cable and the coolant guide of the connection device, so that a transfer of coolant from the coolant line into the coolant guide and/or a transfer of coolant from the coolant guide into the coolant line is enabled.

The locking element can be a lock, in particular a screwable lock, a fastening device, a catch or a similar element, which is adapted to fix the internally cooled cable, after it has been coupled to the connection device, to the connection device so that the cable can be removed from the connection device again only after the locking element has been manually released or unlocked by an operator.

An advantage here is that operational reliability of the energy-supply system during an energy-supply process can be increased, and that in particular unintentional detachment of the internally cooled cable from the connection device during an energy-supply process can be prevented.

In a variant, the energy-supply system can comprise a coolant pump, which is adapted to pump a coolant, in particular a liquid or gaseous coolant, into the at least one coolant line of the internally cooled cable and/or into the coolant guide of the connection device, and/or to pump such a coolant out of the at least one coolant line of the internally cooled cable and/or out of the coolant guide of the connection device.

The coolant pump can be configured as part of the coolant line or as part of the connection device or can be provided separately from the coolant line and the connection device. The coolant pump can be adapted to be coupled and/or connected in a modular manner to the coolant line and/or the connection device. The coolant pump can be coupled and/or connected directly or indirectly to the line for electric current of the internally cooled cable. The coolant pump can be adapted to be supplied with operating energy directly or indirectly through the line for electric current of the internally cooled cable.

An advantage of the coolant pump is that it is able to move the coolant through the internally cooled cable and/or through the connection device and can thereby dissipate heat from the internally cooled cable and/or from the connection device.

In a variant, the coolant guide of the connection device can form at least one coolant circuit with at least one inlet and at least one outlet. The at least one inlet and/or the at least one outlet can be adapted to be connected to the coolant line of the internally cooled cable, so that a transfer of coolant from the coolant line into the coolant guide and/or a transfer of coolant from the coolant guide into the coolant line is enabled when the connection device is mechanically coupled to the connection element of the cable. The at least one inlet and/or the at least one outlet of the connection device can be arranged spatially spaced apart from the contacting device of the connection device. In particular, the inlet and/or the outlet can be separated from one another by an electrically insulating device component of the connection device. The electrically insulating device component can be formed integrally, that is to say in one piece, with the connection device. Coolant is thus prevented from coming into contact with the contacting device of the connection device or with the line for electric current of the internally cooled cable.

The internally cooled cable can optionally comprise at least two coolant lines. A first coolant line can be adapted to be connected to the inlet of the coolant circuit of the connection device when the connection device is mechanically coupled to the connection element of the cable.

A second coolant line can be adapted to be connected to the outlet of the coolant circuit of the connection device when the connection device is mechanically coupled to the connection element of the cable.

An advantage here is that the internally cooled cable can thus form a feed line and a return line for a coolant circuit within the connection device.

A further advantage of an internally cooled cable with at least two coolant lines is that, with a feed line and a return line for a coolant, a temperature gradient within the cable can be flattened out. While the coolant heated by the heat dissipated from the cable and/or the connection device is being discharged from the cable, it can heat those parts of the cable that are cooled comparatively more greatly by a supplied coolant that has not yet been heated. By feeding and returning the coolant through the same cable, a more uniform heat distribution within the cable can thus be effected.

In a further development, the energy-supply system can comprise at least one temperature sensor and/or at least one control device. The temperature sensor can be arranged, for example, at the internally cooled cable, in particular at the at least one line for electric current and/or at the at least one coolant line, or at the connection device, in particular at the contacting device and/or at the coolant guide.

The control device can be adapted to control or to adjust a flow of coolant through the coolant line and/or through the coolant guide on the basis of a recording of the at least one temperature sensor, in particular by controlling and/or adjusting the coolant pump.

An advantage of the temperature sensor and/or of the control device is that the amount of coolant supplied to the energy-supply system and/or the temperature of the coolant supplied to the energy-supply system can be influenced in dependence on an actual cooling requirement of the energy-supply system.

By means of the temperature sensor and/or the control device, it is also possible to respond to a time-variant cooling requirement of the energy-supply system. For example, heating of the internally cooled cable and/or of the connection device can increase during a prolonged energy-supply process, wherein the increasing heating can be determined by means of the temperature sensor and/or the control device and the amount of coolant supplied and/or the temperature of the coolant supplied to the energy-supply system can be adapted in dependence on that determination.

An electrically driven machine, in particular a motor vehicle, can comprise one of the energy-supply systems described above. The connection device for the internally cooled cable and/or the storage device for electrical energy and/or the coolant pump can be configured as components of the electrically driven machine. The electrically driven machine can be in particular a motor vehicle, for example an electrically driven passenger car or truck, or an electrically driven passenger or cargo bike, for example an electrically driven motorcycle.

A method for supplying operating energy to an electrically driven machine comprises the following steps:
Providing an internally cooled cable, which comprises at least one line for electric current and at least one coolant line.
Providing at least one connection device for the internally cooled cable, which connection device comprises a contacting device and a coolant guide and is adapted to be mechanically coupled to a connection element of the internally cooled cable.
Mechanically coupling the connection element of the cable to the connection device, so that the contacting device electrically contacts the at least one line for electric current and an exchange of coolant between the coolant line of the internally cooled cable and the coolant guide of the connection device is enabled.

Further features, properties, advantages and possible modifications will become clear to a person skilled in the art from the following description, in which reference is made to the accompanying schematic figures. In the figures, all the features that are described and/or represented schematically show the subject matter disclosed herein on their own or in any desired combination. The figures are schematically simplified and in particular are not true to scale.

### BRIEF DESCRIPTION OF THE DRAWINGS

The figures show, in each case schematically, an energy-supply system for an electrically driven machine.

FIG. 1 shows, schematically, an example of an energy-supply system for an electrically driven machine with an internally cooled cable and a connection device.

FIG. 2 shows, schematically, an example of an energy-supply system for an electrically driven machine with two internally cooled cables.

FIG. 3 shows, schematically, an example of an energy-supply system for an electrically driven machine with an internally cooled cable that comprises two coolant lines.

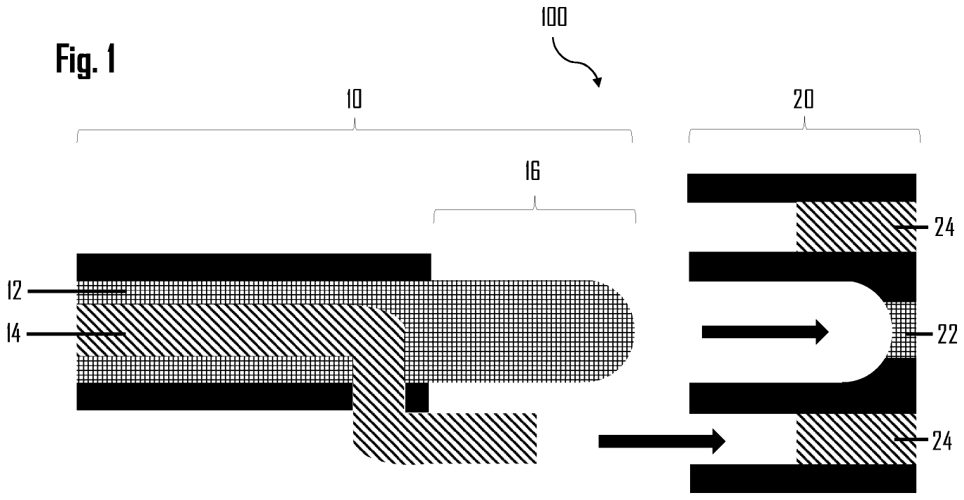

Unless explicitly indicated otherwise, components and parts that correspond or that are comparable in their function are provided with corresponding reference signs in schematic FIGS. 1 to 3.

### DETAILED DESCRIPTION

FIG. 1 shows, schematically, an example of an energy-supply system 100 for an electrically driven machine, with an internally cooled cable 10 and a connection device 20.

The internally cooled cable 10 has at least one line for electric current 12, which is electrically conductively connected to a connection element 16. In the example shown in FIG. 1, the connection element 16 is electrically conductive. Furthermore, the connection element 16 and the line 12 in the example shown in FIG. 1 are formed in one piece, but this is not necessary in all embodiments. In other energy-supply systems (not shown), the cable can also comprise a connection element that is not formed in one piece with the line for electric current.

The internally cooled cable 10 further has a coolant line 14, which is adapted to conduct a liquid or gaseous coolant through the cable 10 and thereby dissipate the heat caused by the electrical resistance of the line 12 in the case where electric current is being passed through.

In the example shown in FIG. 1, the coolant line 14 passes through an insulation of the cable at least at one point of the internally cooled cable 10 and at least a section thereof extends, separate from the line for electric current 12, on the other side of the insulation of the cable, which surrounds the line for electric current 12. However, this is not necessary in all embodiments. Alternatively, the coolant line 14 can also be separate from the line for electric current 12, without passing through the insulation of the cable. In other energy-supply systems (not shown), the coolant line 14 can also be surrounded or at least partially enclosed, up to a transfer point to a coolant guide of a connection device, by an inner or outer insulation of the cable and/or of one or more lines for electric current.

The connection element 16 of the internally cooled cable 10 is configured to be mechanically coupled to a connection device 20 of the energy-supply system 100. In the example shown in FIG. 1, the connection element 16 is configured to be arranged in a correspondingly formed cavity in the connection device 20. In other embodiments (not shown), the connection element, for example, can also have a cavity into which a correspondingly formed contacting device of the connection device can be inserted.

The connection device 20 of the energy-supply system 100 shown in FIG. 1 has a contacting device 22, which is adapted to electrically contact the line for electric current 12 of the internally cooled cable 10 when the connection element 16 has been coupled to or brought into contact with the connection device 20. In the example shown, the contacting device 22 is adapted to contact the line for electric current 12 through the electrically conductive connection element 16.

The connection device 20 of the energy-supply system 100 further comprises the coolant guide 24. The coolant guide 24 is formed through the walls of the connection device 20, which spatially space the coolant line 14 of the cable 10 apart from the contacting device 22 and electrically insulate it. The coolant guide 24 is adapted to conduct a liquid or gaseous coolant along a predetermined path through the connection device. Heat, in particular heat caused by the flow of electric current, can thus be dissipated from the connection device 20. In other words, the coolant guide 24 is formed by one or more coolant channels within the connection element 20, each of which channels is adapted for the passage of an externally supplied liquid or gaseous coolant for cooling the connection device 20.

The coolant line 14 of the internally cooled cable 10 is adapted to be connected to the coolant guide 24 of the connection device 20 when the connection element 16 is arranged in the correspondingly formed cavity in the connection device 20. The coolant line 14 shown in FIG. 1 can be connected to the coolant guide 24 by a plug-in connection, for example. Alternatively or in addition, the energy-supply system can also comprise one or more screw, snap-in and/or magnetic devices and/or similar fastening elements (not shown) for connecting the coolant line 14 to the coolant guide 24. In other words, the energy-supply system 100 at least enables, that is to say makes possible, the transfer of coolant from the coolant line 14 of the internally cooled cable 10 to the coolant guide 24 of the connection device 20 when the connection element 16 is mechanically coupled to the connection device 20.

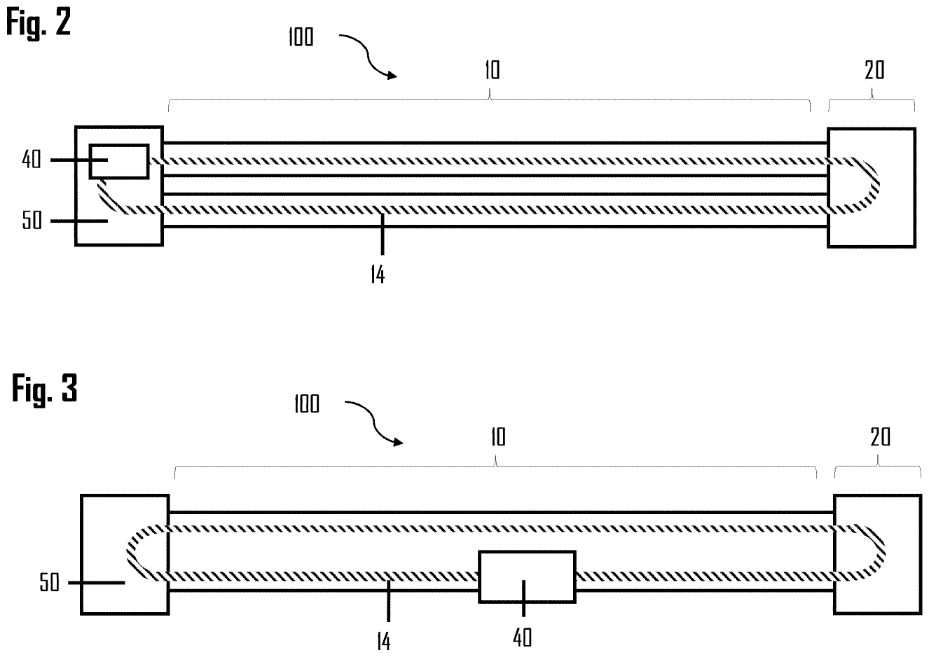

As is further shown schematically in FIG. 2, it is possible by means of two internally cooled cables 10, for example with two of the internally cooled cables shown in FIG. 1, and a connection element 20 to produce a coolant circuit, which makes it possible to cool both the cable 10 and the connection element 20, both devices being cooled by a common coolant.

As is shown schematically in FIG. 2, the energy-supply system 100 can comprise a coolant pump 40, which pumps a coolant, for example a liquid coolant, into the coolant line 14 of the internally cooled cable 10. The coolant that is pumped in can dissipate heat both from the cable itself and from the connection device 20 when the internally cooled cable 10 is coupled to the connection device 20.

As is shown schematically in FIG. 2, the coolant pump 40 can be integrated in an energy-providing device 50, for example, which is able to provide, in addition to electrical operating energy for the electrically driven machine, also a coolant supply. The energy-providing device 50 and/or the coolant pump 40 can optionally further comprise a heat exchanger (not shown) for dissipating the heat taken up by the coolant from the coolant circuit.

FIG. 3 shows, schematically, an alternative energy-supply system 100 with an internally cooled cable 10 and a connection device 20. In the example shown in FIG. 3, the internally cooled cable 10 comprises at least two coolant lines 14, both of which are connected to the coolant guide 24 of the connection device 20, a first of the coolant lines 14 serving as a feed line for the coolant and a second of the coolant lines 14 serving as a return line for the coolant. Only a single cable is thus required to produce a coolant circuit. Furthermore, those parts of the cable 10 that are mostly cooled by the as yet unheated coolant flowing into the cable are heated by the coolant that flows back and has already been heated by the line for electric current 12 (not shown in FIGS. 2 and 3 for reasons of clarity) and by the connection device 20, so that uniform heat distribution within the cable 10 is further improved.

As is further shown schematically in FIG. 3, the coolant pump 40 can also be integrated directly in the internally cooled cable 10 or can be configured as an integral component of the cable 10. The coolant pump 40 can here be supplied with electrical operating energy from the energy-providing device 50 in particular through the line for electric current 12 of the cable 10.

It will be appreciated that the exemplary embodiments explained above are not exhaustive and do not limit the subject matter disclosed herein. In particular, it will be apparent to the person skilled in the art that he can combine the described features with one another as desired and/or can omit various features without departing from the subject matter disclosed herein.

1. An energy-supply system for an electrically driven machine, with
an internally cooled cable which comprises at least one line for electric current and at least one coolant line wherein at least a section of the coolant line is separate from the line for electric current, and
a connection device for the internally cooled cable , which connection device comprises a contacting device and a coolant guide and is adapted to be mechanically coupled to a connection element of the internally cooled cable, wherein
the contacting device is adapted to electrically contact the at least one line for electric current when the connection device is mechanically coupled to the connection element of the cable,
wherein
the energy-supply system is adapted to enable a transfer of coolant from a section of the coolant line of the internally cooled cable that is separate from the line for electric current to the coolant guide of the connection device, or from the coolant guide of the connection device to the section of the coolant line of the internally cooled cable that is separate from the line for electric current when the connection element of the cable is mechanically coupled to the connection device.

2. The energy-supply system as claimed in claim 1, wherein
the electrically driven machine is a motor vehicle, and/or
the connection device for the internally cooled cable is arranged at the electrically driven machine and/or is integrated in the electrically driven machine.

3. The energy-supply system as claimed in claim 1, further comprising
a storage device for electrical energy, wherein the connection device for the internally cooled cable is adapted to charge the storage device with electrical energy supplied through the line for electric current of the internally cooled cable when the connection device is mechanically coupled to the connection element of the cable.

4. The energy-supply system as claimed in claim 1, wherein
the connection device comprises at least one locking element, which is adapted to mechanically fix the connection element of the internally cooled cable, and/or to connect together the coolant line of the internally cooled cable and the coolant guide of the connection device, so that a transfer of coolant from the coolant line into the coolant guide and/or a transfer of coolant from the coolant guide into the coolant line is enabled.

5. The energy-supply system as claimed in claim 1, further comprising
a coolant pump, which is adapted to pump liquid coolant into the at least one coolant line of the internally cooled cable and/or into the coolant guide of the connection device and/or to pump such a coolant out of the at least one coolant line of the internally cooled cable and/or out of the coolant guide of the connection device.

6. The energy-supply system as claimed in claim 1, wherein
the coolant guide of the connection device forms a coolant circuit with at least one inlet and at least one outlet, wherein
the at least one inlet and/or the at least one outlet is adapted to be connected to the coolant line of the internally cooled cable, so that a transfer of coolant from the coolant line into the coolant guide and/or a transfer of coolant from the coolant guide into the coolant line is enabled when the connection device is mechanically coupled to the connection element of the cable.

7. The energy-supply system as claimed in claim 6, wherein
the internally cooled cable comprises at least two coolant lines, wherein
a first coolant line is adapted to be connected to the inlet of the coolant circuit of the connection device when the connection device is mechanically coupled to the connection element of the cable, and
a second coolant line is adapted to be connected to the outlet of the coolant circuit of the connection device when the connection device is mechanically coupled to the connection element of the cable.

8. The energy-supply system as claimed in claim 1, further comprising
at least one temperature sensor and/or at least one control device, wherein
the temperature sensor is arranged at the internally cooled cable at the at least one line for electric current and/or at the at least one coolant line, or at the contacting device and/or at the coolant guide, and/or wherein
the control device is adapted to control and/or adjust the cooling pump to thereby adjust a flow of coolant through the coolant line and/or through the coolant guide on the basis of a recording of the at least one temperature sensor.

9. A motor vehicle, comprising
an energy-supply system as claimed in claim 1, wherein
the connection device for the internally cooled cable and/or the storage device for electrical energy and/or the coolant pump are configured as components of the electrically driven machine.

10. A method for supplying operating energy to an electrically driven machine, comprising the following steps:
providing an internally cooled cable, which comprises at least one line for electric current and at least one coolant line, wherein at least a section of the coolant line is separate from the line for electric current; and
providing at least one connection device for the internally cooled cable, which connection device comprises a contacting device and a coolant guide and is adapted to be mechanically coupled to a connection element of the internally cooled cable;
mechanically coupling the connection element of the cable to the connection device, so that the contacting device electrically contacts the at least one line for electric current and an exchange of coolant between a section of the coolant line of the internally cooled cable that is separate from the line for electric current and the coolant guide of the connection device is enabled.
